(19) United States
(12) Patent Application Publication
(10) Pub. No.: US 2015/0142149 A1
(43) Pub. Date: May 21, 2015

(54) Method and computer-based tool for composite-structure fabrication design

(71) Applicant: Collier Research and Development Corporation, Newport News, VA (US)

(72) Inventors: Craig Shelton Collier, Newport News, VA (US); Phillip Wade Yarrington, Hampton, VA (US); John Benjamin Maitin, Newport News, VA (US); Ryan Christopher Lucking, Pittsburgh, PA (US); James Joseph Ainsworth, III, Yorktown, VA (US)

(73) Assignee: Collier Research and Development Corporation, Newport News, VA (US)

(21) Appl. No.: 13/998,603

(22) Filed: Nov. 15, 2013

(51) Int. Cl. G05B 19/4097; G06F 17/50

(52) U.S. Cl. CPC G05B 19/4097; G06F 17/50
USPC 700/98

(57) ABSTRACT

A computer system and method are provided for generating a composite-structure fabrication design. During execution of the method on the computer system, a plurality of user interfaces prompt a user to enter generic design criteria as well as specific fabrication rules. Both generic design criteria and specified fabrication rules are considered simultaneously when determining candidates for fabrication designs. An optimization routine applied to the candidates yields an optimum fabrication design.

### FIELD OF THE INVENTION

The invention relates generally to composite structure design, and more particularly to a method and computer-based tool to include user interfaces that facilitate development of a fabrication design for a composite structure.

### BACKGROUND OF THE INVENTION

A wide variety of commercially-available computer-aided design products have been used for years to perform finite element analysis (FEA) routines and non-FEA routines in order to solve the problem of structure optimization. In terms of composite structures, these design products allow a user/designer to evaluate a large number of potential problem solutions (e.g., ply counts and ply orientation for a laminate-based composite structure) along with analysis to provide an optimum solution. For example, one such design product known as HYPERSIZER has been commercially-available since 1996 from Collier Research and Development Corporation, Hampton, Va. An end user or fabricator using these conventional design products must then evaluate the optimum solution to assure that it will satisfy their in-house criteria, their customer's criteria, local and/or national regulations, etc. Accordingly, the generated optimum solutions provided by conventional design products are generic in that they do not take into account an end user's specific criteria. This lengthens the overall design process and ultimately increases the costs associated therewith since the end product does not satisfy other needs and thus requires manual or “by hand” method iterations in order to properly account for all the concerns of the end user.

### SUMMARY OF THE INVENTION

Accordingly, it is an object of the present invention to provide a computer-based method and system for use in composite-structure fabrication design.

Another object of the present invention is to provide a computer-based method and system that streamlines composite-structure fabrication design.

Other objects and advantages of the present invention will become more obvious hereinafter in the specification and drawings.

In accordance with the present invention, a computer system and method are provided for generating a composite-structure fabrication design. The computer system includes
a database for storing data to include analysis templates, material data, and model data,
a memory device for storing a computer program,
a display device for generating visual images of a plurality of user interfaces,
an input device for receiving user selections, and
a processor for executing the computer program.
   Upon execution of the computer program, the display device displays a first subset of the user interfaces that present selection options for the data. The data identified by the selection options corresponding to user selections are used to determine a composite structure model. The display device displays a second subset of the user interfaces that illustrate structural components of the composite structure model. The second subset of the user interfaces provide access to ones of the user interfaces specifying fabrication rule options. Fabrication rules are selected from the fabrication rule options via user selections. The selected fabrication rules along with the composite structure model are used to determine a plurality of candidates for a composite structure fabrication based on the composite structure model. Each of the candidates defines a unique ply-by-ply definition of the composite structure fabrication. The display device displays a third subset of the user interfaces that illustrates each ply-by-ply definition. An optimization routine is performed on the plurality of candidates to select an optimum one thereof. The third subset of the user interfaces are updated to visually indicate the optimum one of the plurality of candidates.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a block diagram of a computer system that can be configured for the generation of a composite-structure fabrication design in accordance with an embodiment of the present invention;

FIG. 2 is a flow diagram of a method of executing a computer program on a processor to generate a composite-structure fabrication design in accordance with an embodiment of the present invention;

FIG. 3 is a screenshot of a displayed user interface that presents a user with options related to composite-structure analysis templates and model data;

FIG. 4 is a screenshot of a displayed user interface that provides access to user interfaces used to input fabrication rules;

FIG. 5A is a screenshot of a displayed user interface that provides access to sets of options governing fabrication criteria of the fabrication design;

FIG. 5B is a screenshot of a displayed user interface that provides access to additional sets of options governing fabrication criteria of the fabrication design;

FIG. 6 is a screenshot of a displayed user interface that presents options governing ply angles for the structural components;

FIG. 7 is a screenshot of a displayed user interface that presents options governing tooling when fabricating the structural components;

FIG. 8 is a screenshot of a displayed user interface that presents options governing repairs for the structural components;

FIG. 9 is a screenshot of a displayed user interface that presents options governing dimensionless ratios for the composite structure model's structural components and fabrication sublaminate stacks for the structural components;

FIG. 10 is a screenshot of a displayed user interface that presents a user with options related to ply material selection;

FIG. 11 is a screenshot of a displayed user interface that illustrates preliminary sizing optimum designs developed in consideration of the user selections made from the options governing fabrication;

FIG. 12 is a screenshot of a displayed user interface that presents layup rule options;

FIG. 13 is a screenshot of a displayed user interface that presents normalized variable ranges for all components in an assembly;

FIG. 14 is a screenshot of a displayed user interface that illustrates detailed component laminates to include ply-by-ply specifics developed in consideration of the user selections made from the options governing fabrication;

FIG. 15 is a screenshot of the displayed user interface shown in FIG. 14 updated to indicate an optimum fabrication design candidate following execution of optimization analysis;

FIG. 16A is a screenshot of an I-panel cross-section illustrating a ply-by-ply layup coded to show ply orientation for the optimum fabrication design candidate to include sublaminates;

FIG. 16B is a screenshot of an T-panel cross-section illustrating a ply-by-ply layup coded to show ply orientation for the optimum fabrication design candidate to include sublaminates;

FIG. 16C is a screenshot of an enlarged view of a rib-to-skin interface to more clearly show ply angles; and

FIG. 17 is perspective view of a wing box model illustrating the contiguous components thereof.

### DETAILED DESCRIPTION OF THE INVENTION

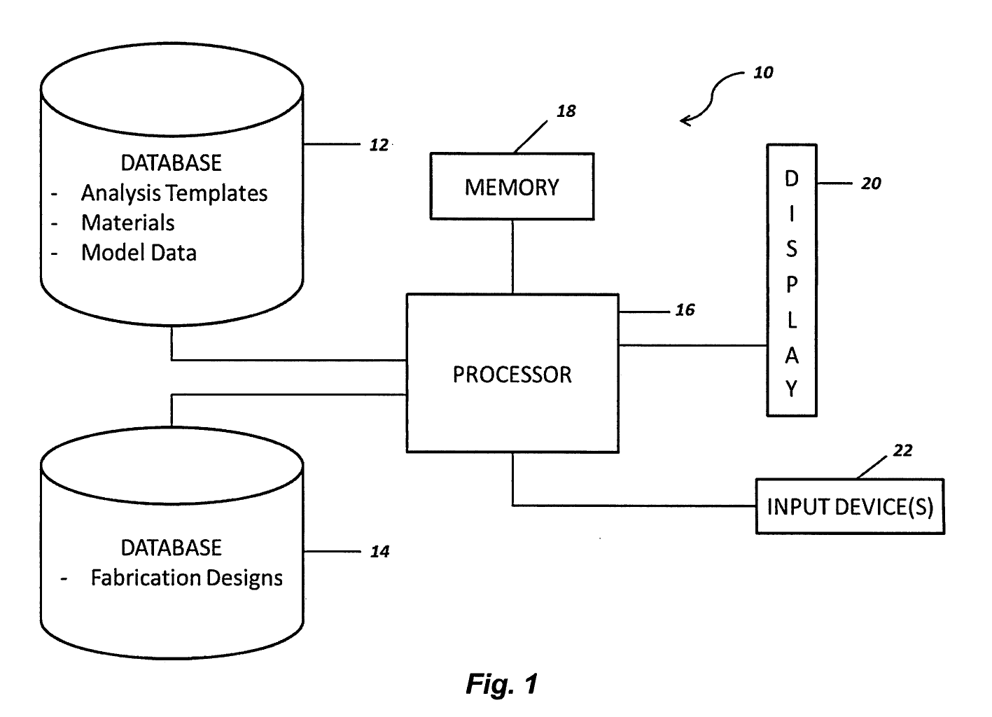

Referring now to the drawings and more particularly to FIG. 1, a computer system 10 is shown that is configured for the generation of a composite-structure fabrication design in accordance with an embodiment of the present invention. As used herein, the term “composite structure” refers to a multiple-ply laminate skin(s) supported on/by multiple-ply laminate longerons/stiffeners. The term “fabrication design” refers to a computer-aided design for a composite structure that has been optimized in terms of generic structural criteria as well as being optimized in terms of a variety of particular fabrication rules that are selected by a designer during the design process. That is and as will be explained further below, the present invention streamlines composite structure design by presenting a plurality of user interfaces that allow a user/designer to specify a variety of fabrication rules in an easy-to-access and logical fashion. Generic structural criteria and user selections for “local” fabrication rules are then optimized simultaneously to provide a fabrication design.

Computer system 10 includes one or more databases to store data used in the composite-structure fabrication design process as well as fabrication designs that are generated. By way of illustrative example, a database 12 stores data used by the present invention and a database 14 stores data generated by the present invention. In general and as is known in the art of computer-aided composite-structure design, database 12 stores basic analysis templates for structures that might be designed (e.g., wing boxes, fuselages, etc., for aircraft design), data associated with materials that can be used for the composite structures (e.g., tape material, fabric material, etc.), and model data (e.g., finite element modelers such as Patran or Femap, FEA solvers such as Nastran, Ansys or Abaqus, etc.) that can be used to generate and simulate a composite structure model.

A processor 16 executes a computer program that configures computer system 10 for the generation of a composite-structure fabrication design in accordance with the present invention. The computer program can be stored on a memory device 18 coupled to processor 16. A display 20 coupled to processor 16 is used to display a number of user interfaces generated during various executions of the computer program. Each of the user interfaces presents a user (not shown) with selection options. User-selected choices made from the selection options will be used by the computer program during subsequent program executions. The user provides his selections to the computer program (being executed on processor 16) using one (or more) input device(s) 22 (e.g., mouse, keyboard, touch screen for display 20, etc.), the types and number of which are not limitations of the present invention.

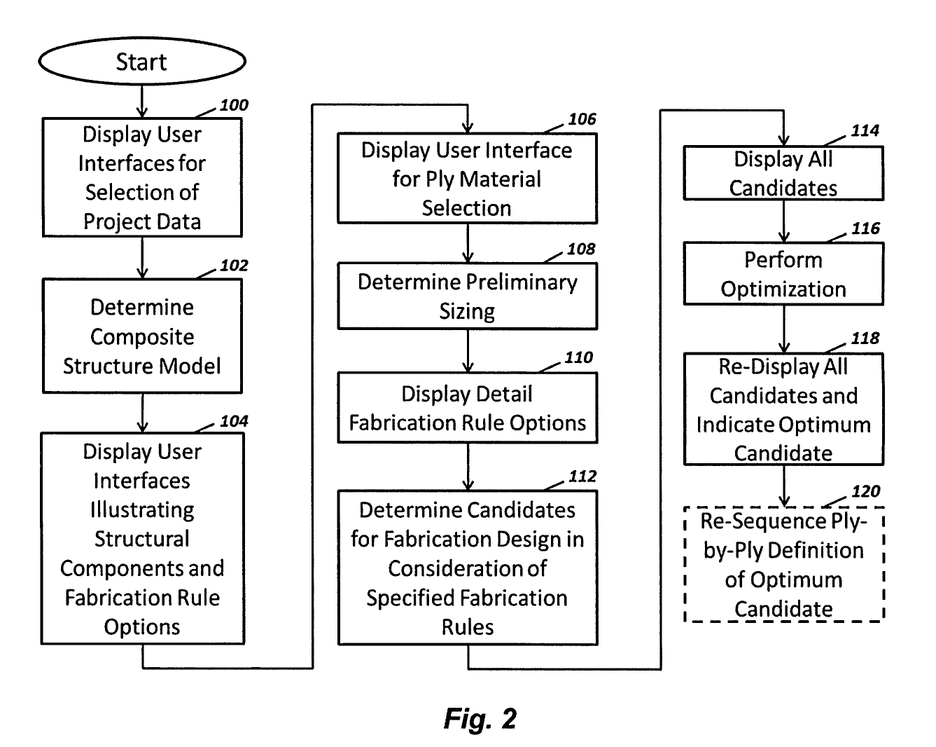

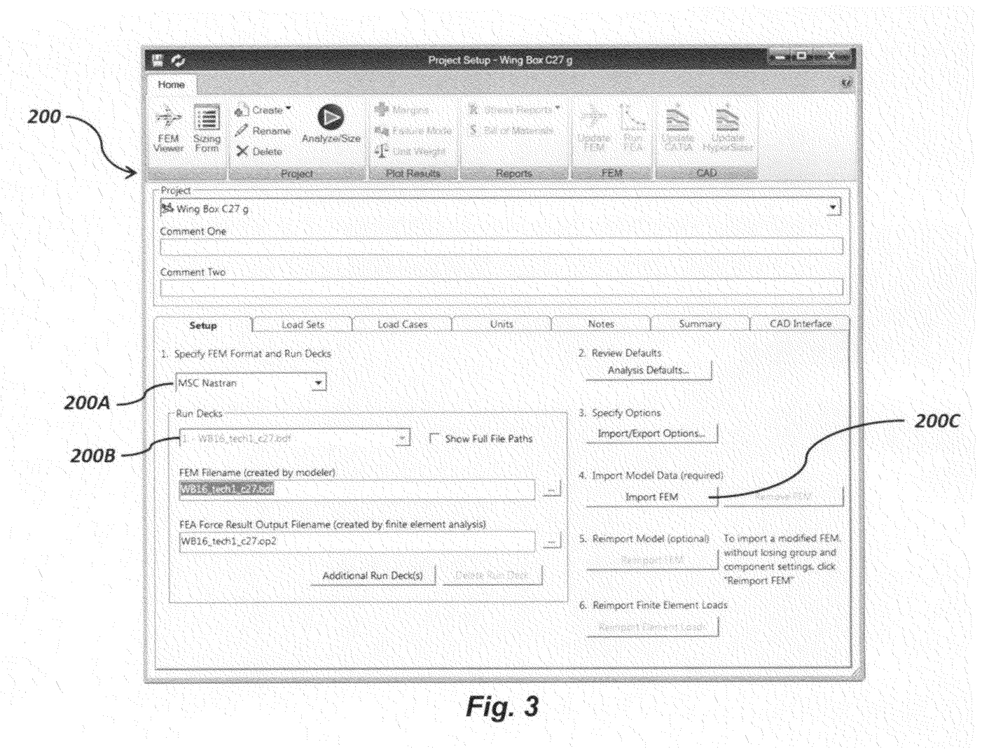

When computer system 10 is configured by the computer program in accordance with the present invention, a composite-structure fabrication design proceeds as shown in the flow diagram illustrated in FIG. 2. The various user interfaces displayed on display 20 by the present invention are depicted in the screenshots illustrated in FIGS. 3-15. The screenshots and method steps associated therewith (FIG. 2) will be referred to simultaneously. It is to be understood that the illustrated order of the method steps is exemplary and that a user/designer can implement the steps in other orders without departing from the scope of the present invention.

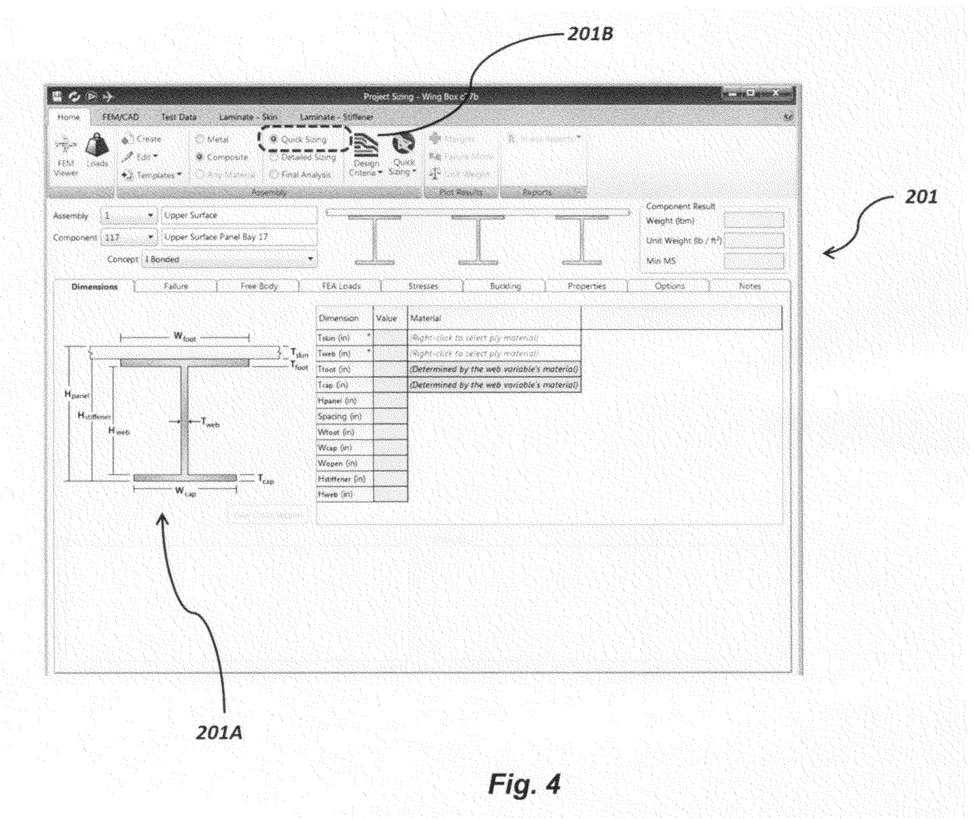

After the computer program is started, processor 16 executes a first portion thereof (step 100) to cause display 20 to display a user interface 200 illustrated in the screenshot shown in FIG. 3. User interface 200 presents the user with a number of selection options for initiating a design project. Specifically, the “Setup” view shown in FIG. 3 allows the user to select/specify (among other things) a template at 200A (e.g., an existing analysis template stored in database 12) and model data at 200B. The analysis template and model data are applied by selecting the “Import Model Data” button at 200C. That is, after inputting selections on user interface 200, the user instructs the computer program to execute the next portion thereof (step 102) to thereby cause display 20 to display a user interface 201 illustrated in the screenshot shown in FIG. 4. Briefly, step 102 executes the portion of the computer program that applies the user selections made on user interface 200 in order to determine a generic composite structure model based the analysis template and model data selected. The term “generic” as used herein indicates that the model design has not taken customer and/or local fabrication constraints into consideration. The portion of the computer program executing step 102 is well known in the art.

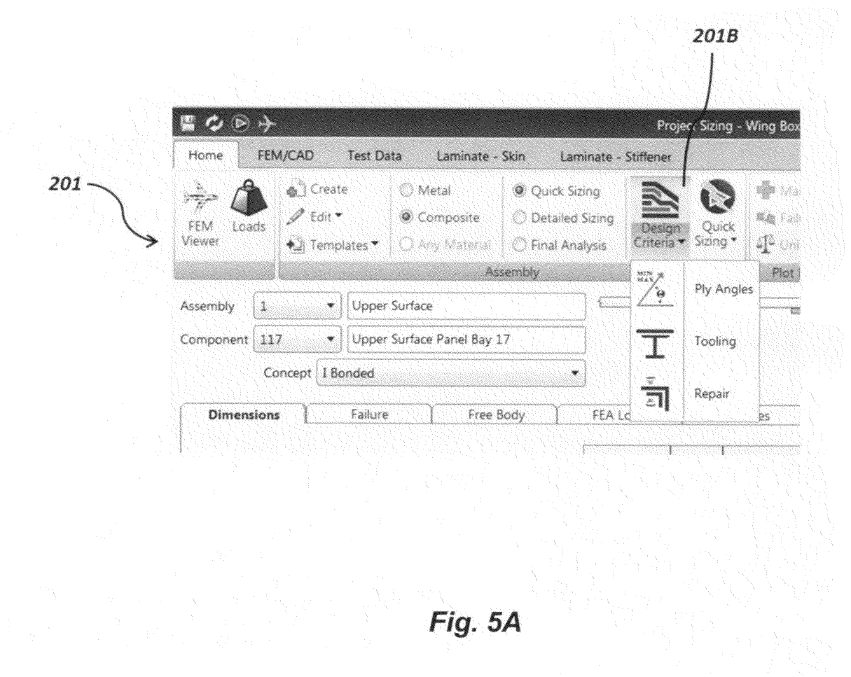

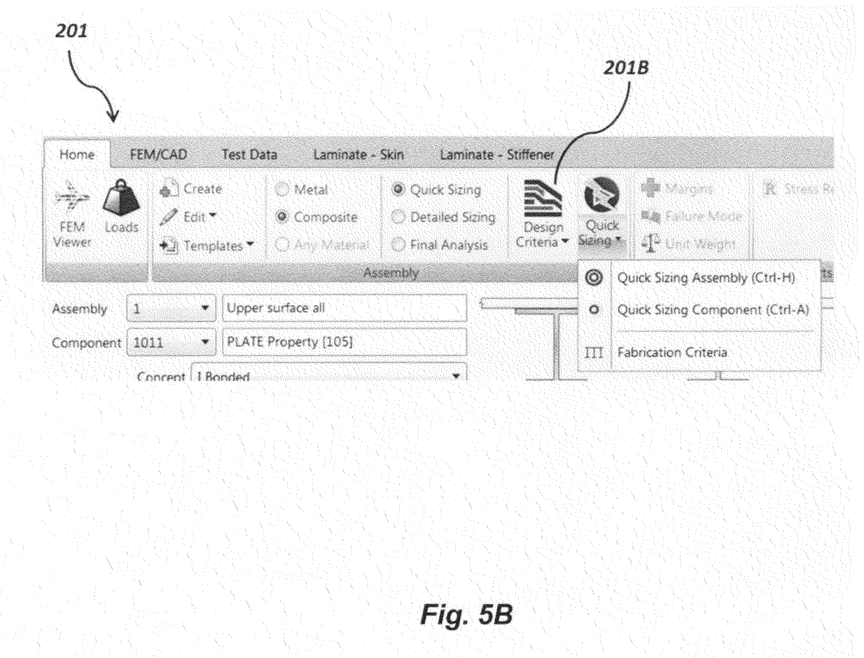

Step 102 generates the basic structure model that is ready for fabrication rule selection in accordance with the present invention. Briefly, completing/executing user interface 200 causes display 20 to display user interface 201 shown in FIG. 4. User interface 201 provides a user with a visual representation of a cross-section of a structural component along with its relevant parameters in view 201A. User interface 201 also presents the user with ready access to fabrication rule selection interfaces via drop down menus on toolbar 201B. The drop down menus are illustrated in FIGS. 5A and 5B.

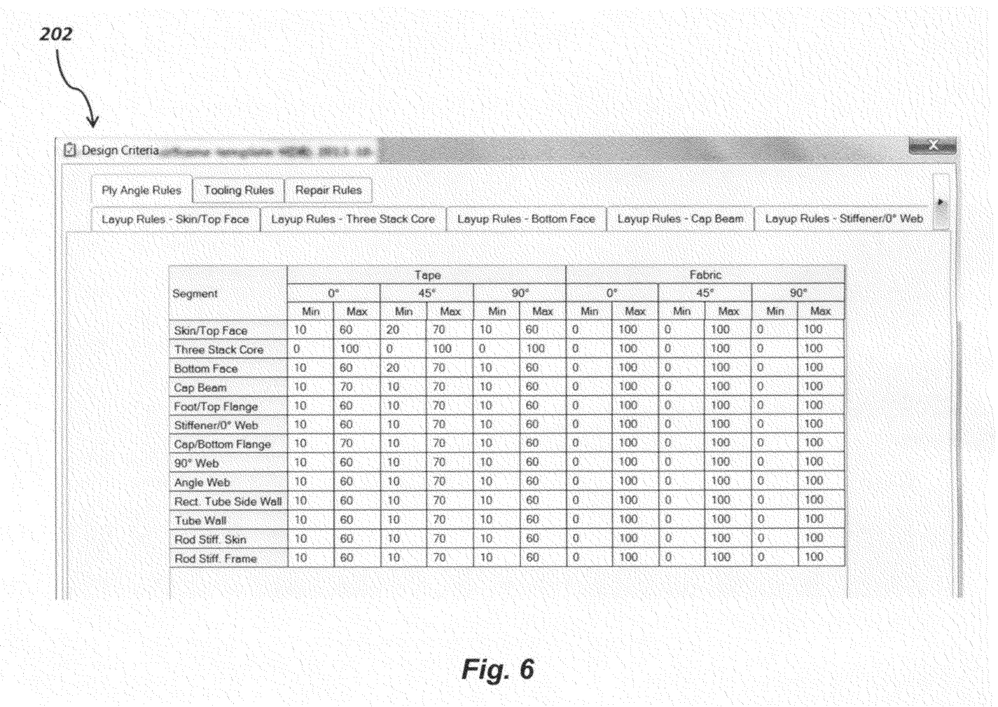

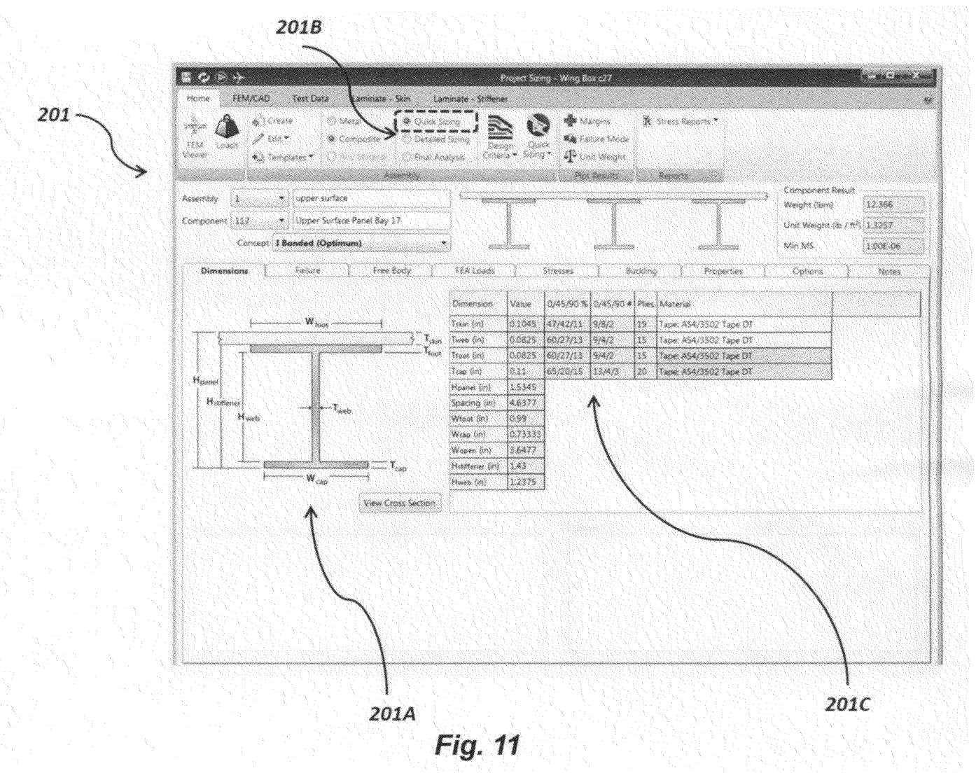

From interface 201, the user/designer can access options related to the user's internal fabrication requirements, a manufacturer's fabrication requirements, and/or a regulatory authority's fabrication requirements. In order to streamline the design process, the present invention integrates a user's specific fabrication needs/rules into the analysis that generates candidates for a fabrication design. The present invention achieves this efficiently and seamlessly by having user interface 201 provide the user with easy access to multiple user interfaces with a variety of fabrication rule options. The various fabrication rule options are presented on display 20 so that a user can make specific fabrication rule selections using input device 22. More specifically, access to user interfaces presenting fabrication rule options are made via drop down menus (as shown in FIGS. 5A and 5B) accessed from the toolbar 201B on user interface 201. Each such access causes the computer program at step 104 to display a user interface that presents a set of fabrication rule options. The set of user interfaces that provide for input/selection of fabrication rules required for preliminary sizing (i.e., “Quick Sizing” as shown on the interfaces) are shown in FIGS. 6-9. As will be explained further below, preliminary sizing generates an output interface (FIG. 11) that provides a user/designer with information on component stiffness and weight that has accounted for fabrication rules not previously considered in prior art design products. This preliminary (or interim) sizing information is important to those personnel in a design group that are concerned with stress evaluation.

In FIG. 6, a user interface 202 is displayed on display 20 after the user accesses “Ply Angles” from the drop down menu on interface 201 shown in FIG. 5A. User interface 202 presents the user with minimum percentages and maximum percentages of ply orientations for each of the various structural assemblies. These angle bounds are generally established by a company's materials and processing department based on test data of fabricated specimens. This data is used as a first step in the optimization process to thereby avoid, at the early phases of a design process, the consideration of unusable design configurations that would later have to be manually filtered out.

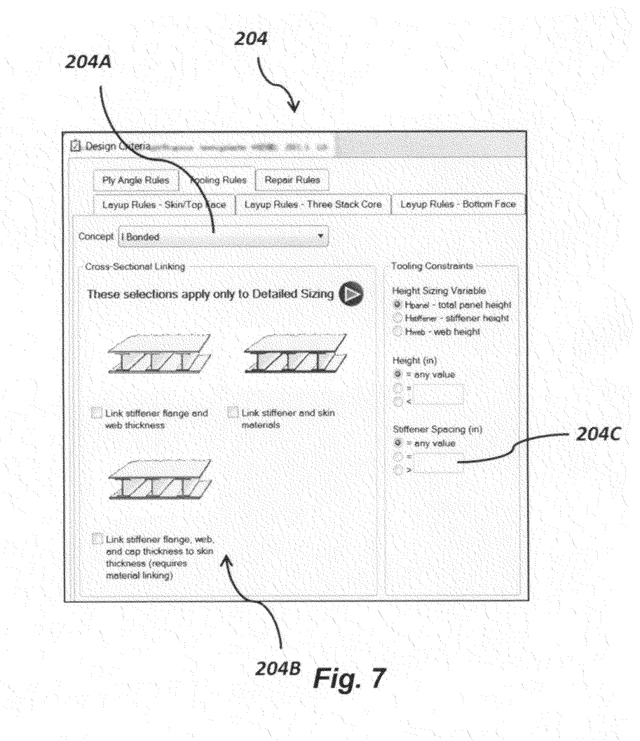

In FIG. 7 a user interface 204 is displayed on display 20 after the user accesses “Tooling” from the drop down menu on interface 201 shown in FIG. 5A. User interface 204 allows the user to identify the structural component's construction concept (e.g., I bonded, T bonded, Z bonded, J bonded, etc.) at drop down menu 204A. User interface 204 also provides the user with tooling options related to which structural components are to be linked during fabrication via view 204B and provides for the specification of stiffener spacing in a fabrication design at 204C. Since stiffener spacing is generally fixed for actual fabrication by a particular manufacturer's capabilities, a user entry at 204C will force a fabrication design to account for a manufacturer's tooling capabilities/requirements. For metals, the linking of stiffener options dictate if the part is fabricated as a bent sheet metal or as an extrusion with each flange and web a possible different thickness.

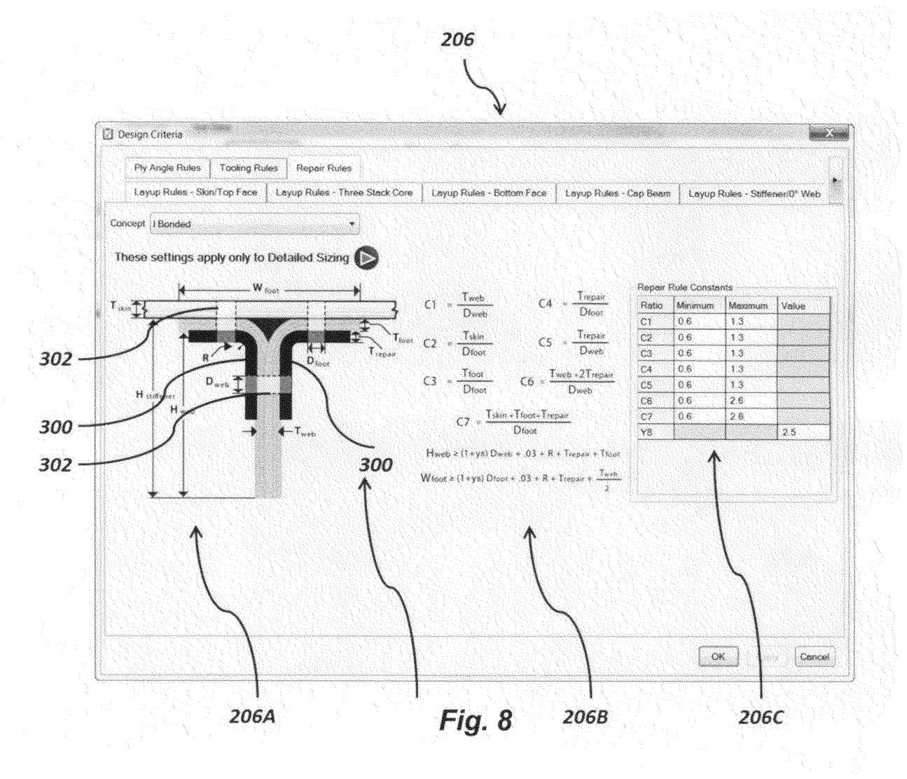

In FIG. 8 a user interface 206 is displayed on display 20 after the user accesses “Repair” from the drop down menu on interface 201 shown in FIG. 5A. User interface 206 presents the user with a view 206A of a cross-section of a structural component with repair angles 300 positioned adjacent the structural component as well as holes 302 used to receive repair rivets (not shown). Definitions of structural component dimensions, repair angle 300 thickness, and diameter of holes 302 are provided in view 206A. Adjacent to view 206A, user interface 206 presents a view 206B of a number of dimensionless ratios relating various structural component thicknesses and diameters of holes 302. Finally, rules that govern the ratios in view 206B can be input by the user (via input device 22) in the table shown in view 206C. By providing user interface 206 as part of the design process, a customer's repair criteria are integrated into fabrication design and its optimization.

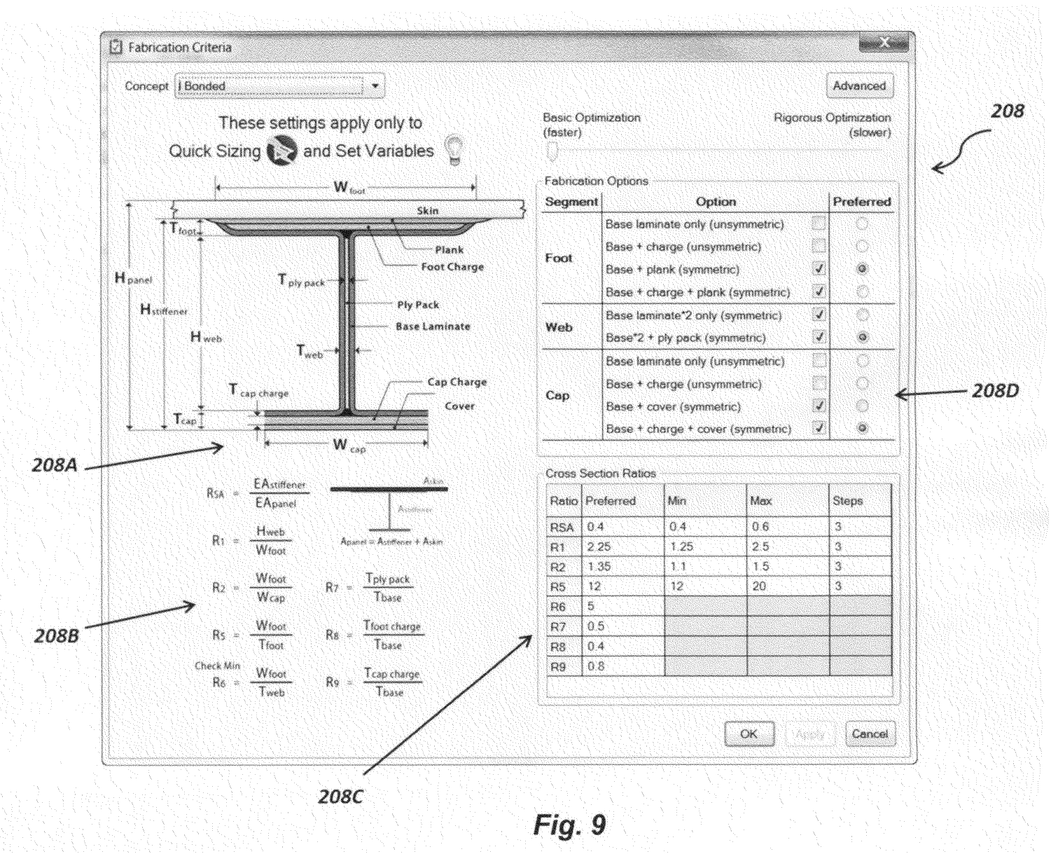

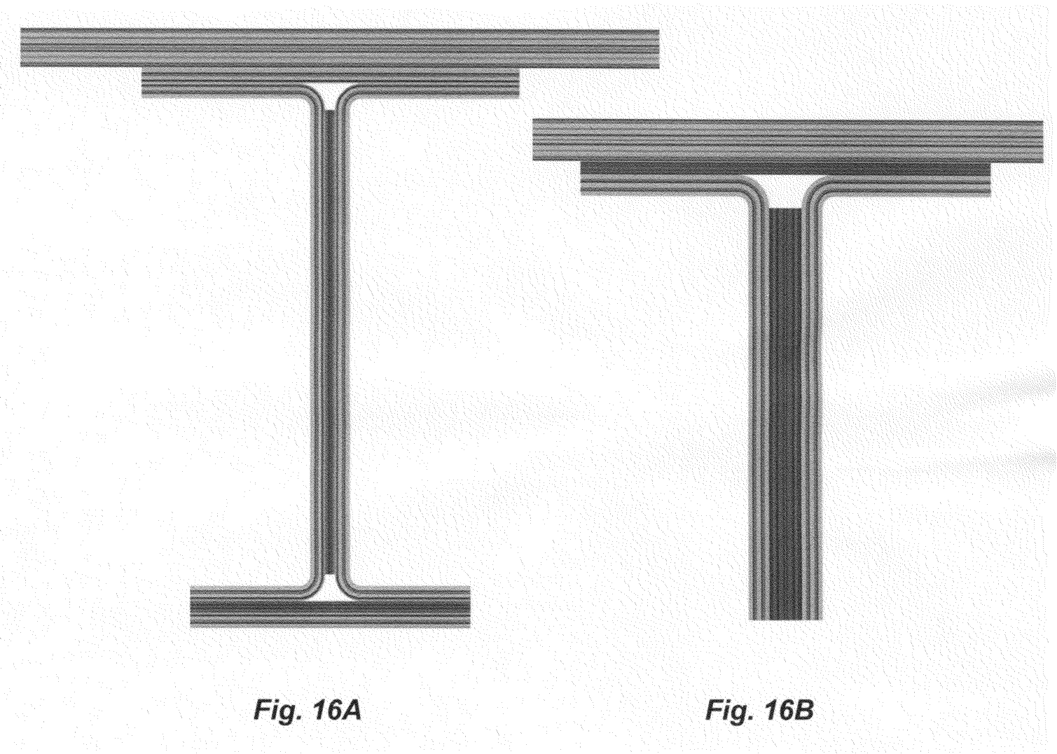

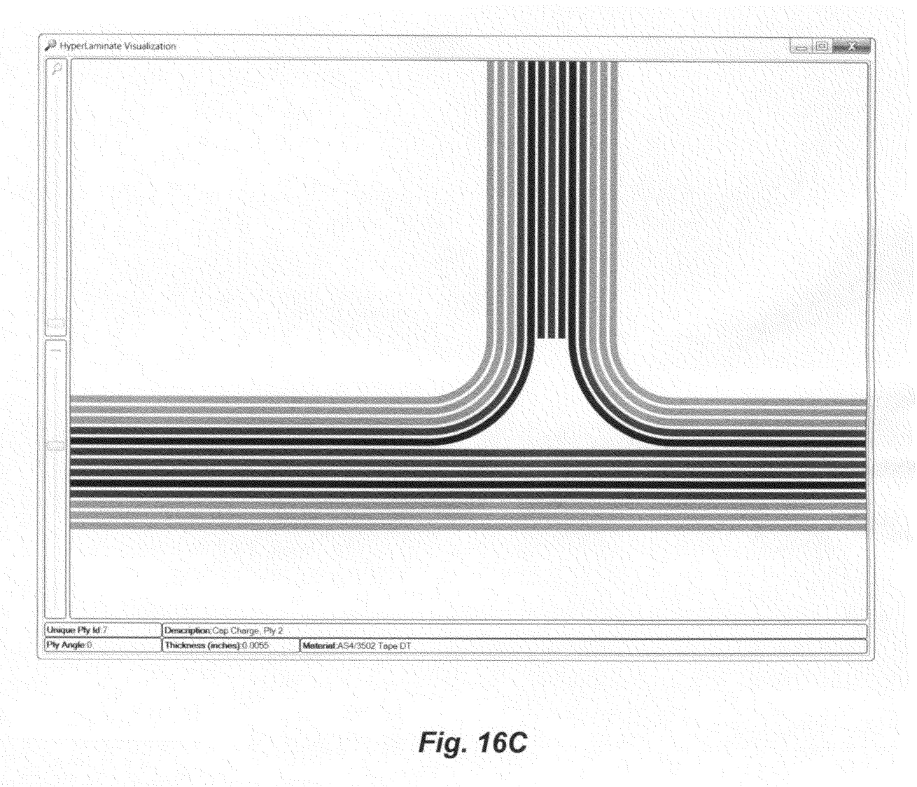

In FIG. 9, a user interface 208 (i.e., entitled “Fabrication Criteria”) is displayed on display 20 after the user accesses it via the drop down menu on user interface 201 shown in FIG. 5B. User interface 208 includes a view 208A of a cross-section of a structural component identifying a plurality of dimensions that are relevant to multiple-ply laminate composite structures. Immediately beneath view 208A is a view 208B showing definitions of dimensionless ratios that are applicable to all component parts of an assembly regardless of a component's thickness which can vary depending on its location in an assembly. Rules that govern these ratios can be input by the user in the table shown in view 208C where acceptable ranges for certain ratios can be expanded or tightened based on an end user's needs. User interface 208 also allows the user to specify sublaminates (i.e., laminate regions that are part of a laminate structure and are treated as an individual layer) for various portions of the structural components by making such selections from the options illustrated in view 208D. These user made selections are paramount to tailoring the fabrication design to be optimal for a customer's fabrication process as will be explained later herein with the aid of FIGS. 16A, 16B and 16C.

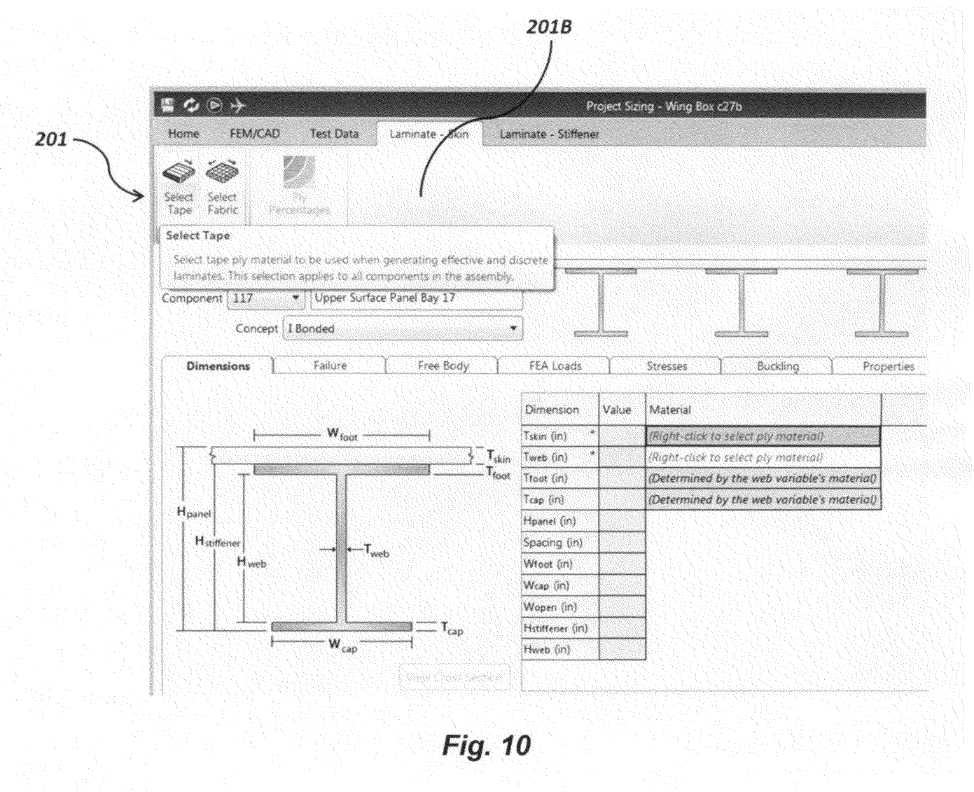

Once the user has made the various fabrication rule selections on the user interfaces illustrated in FIGS. 6-9, the user returns to user interface 201 for ply material selection in step 106. That is, as illustrated in FIG. 10, a user accesses the tape and fabric selection options from toolbar 201B.

At this point in the design process, the user has input sufficient data and rules to perform a preliminary sizing (i.e., “Quick Sizing” on the interfaces' toolbars) at step 108. As mentioned above, this preliminary sizing step generates effective stiffness and accurate weights along with significant fabrication design data for each component of an assembly. By way of example, view 201C shown in FIG. 11 displays the results of a preliminary sizing in which the optimal components' cross-sectional dimensions and ply counts in each of the primary 0, +45, −45, and 90 fiber orientations.

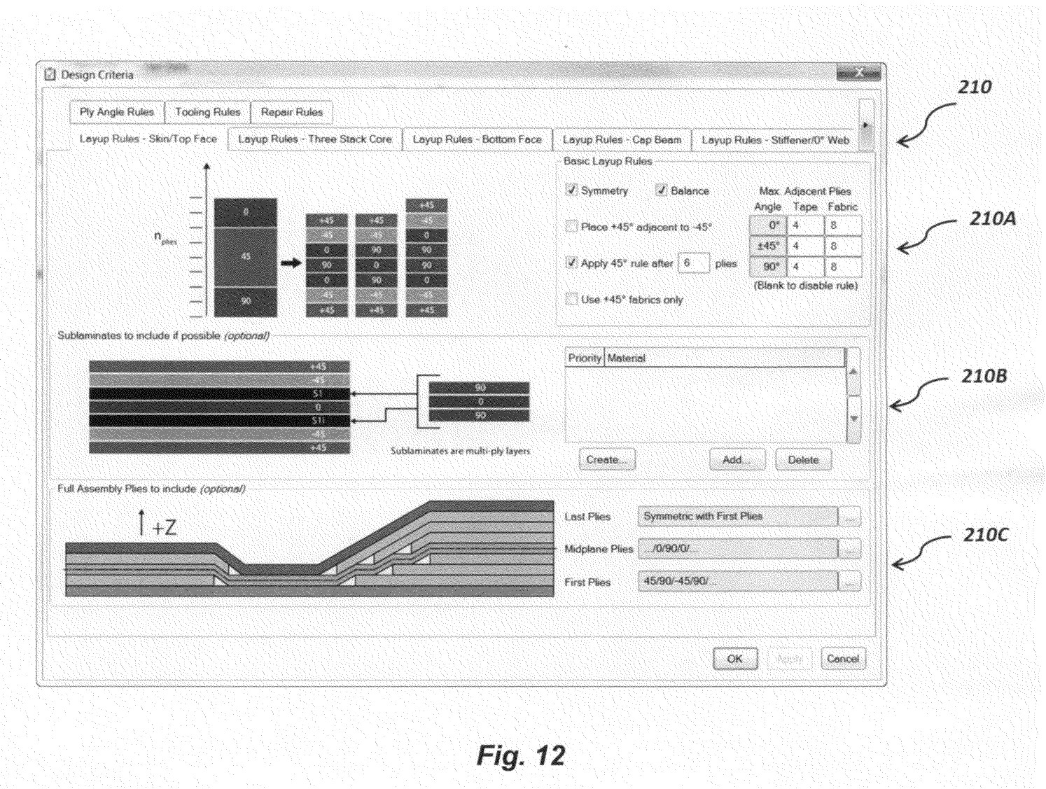

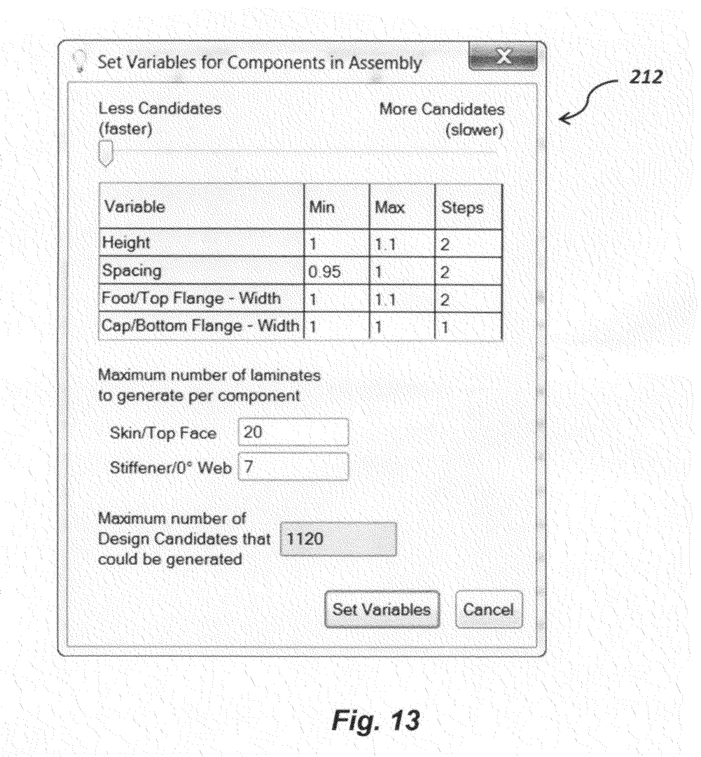

Following the above-described preliminary sizing, the user accesses interfaces specifying more detailed fabrication criteria at step 110 by selecting “Detail Sizing” on toolbar 201B of interface 201. Next, a layup rules options interface and set variables interface can be accessed from user interface 201. More specifically, a user accesses the “Design Criteria” on toolbar 201B to cause display 20 to display a layup rules interface 210 shown in FIG. 12 where a user/designer can specify a collection of different industry specific fabrication options on form at view 210A. These options are founded on years of fabrication testing to improve strength and reduce part warpage after removal from the tool, and hence form the basis of well-accepted guidelines in the manufacture of composites. View 210B allows the input of assembly sublaminates that are premade kits of bundled fabric and/or tape layers supplied by vendors that speed up the fabrication process. View 210C allows the user to require “full body” continuous plies to be applied on the entire tooling assembly surface. This practice in the fabrication process speeds development of the part, and provides valuable damage tolerant protection. The functions provided in views 210A, 210B, and 210C provide unique and novel additional capability beyond conventional laminate optimization tools to thereby avoid the consideration of unusable configurations that would later have to be manually filtered out. FIG. 13 illustrates a “Set Variable” interface 212 that allows a user/designer to expand the bounds around each normalized preliminary-sizing optimal fabrication variable.

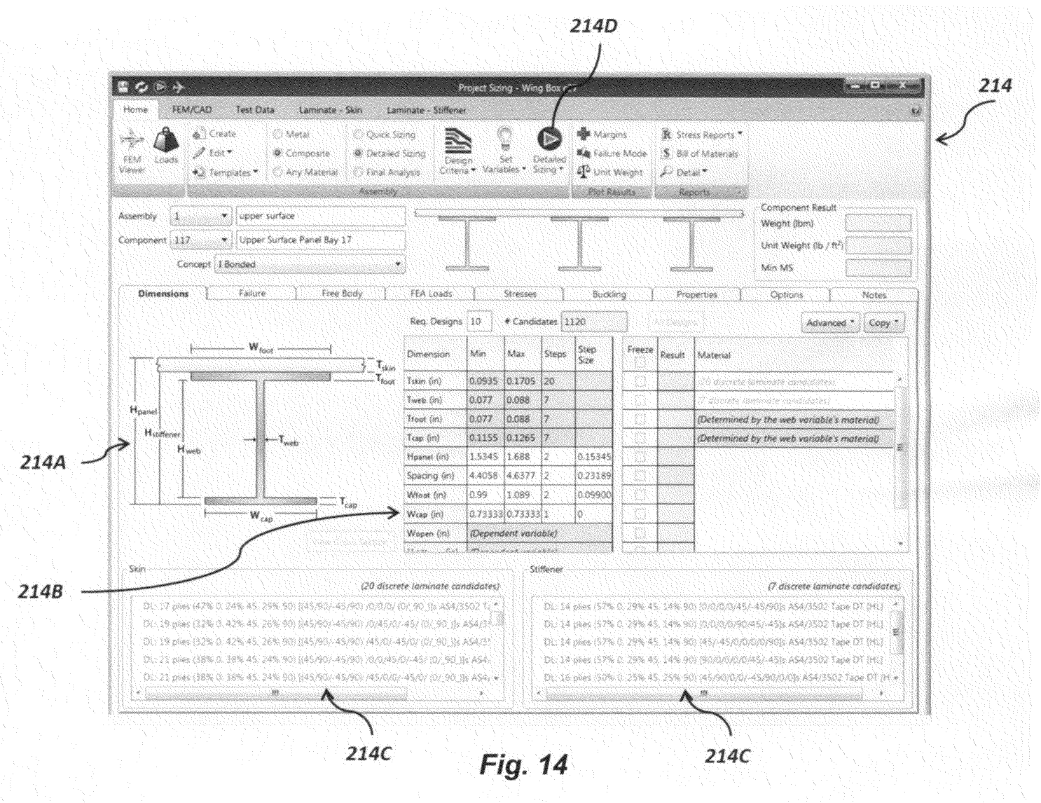

Using the above-described detailed fabrication rules, processor 16 executes the portion of the computer program at step 112 that applies all of the user selections for the fabrication rules to the generic composite structure model and ply counts. That is, step 112 determines fabrication design candidates that consider the generic composite structure model along with the specified fabrication rules. Step 112 involves simultaneously processing all of the fabrication criteria made available through the interfaces shown in FIGS. 6, 7, 8, 9 and 12 along with optimization for strength and stability using the analysis templates. The resulting candidates determined through step 112 are displayed at step 114 on display 20. More specifically, FIG. 14 is a screenshot of a user interface 214 displayed on display 20 at step 114. User interface 214 illustrates a view 214A of a structural component cross-section, a view 214B of the minimum and maximum thicknesses defined by the candidates of the various portions of the structural components, and a view 214C of the ply-by-ply definitions (to include ply angles) for all of the fabrication design candidates.

In order to select one of the fabrication candidates, an optimization analysis is performed at step 116. That is, the portion of the computer program that performs the final optimization analysis is invoked when the user selects “Detailed Sizing” from toolbar 214D of interface 214. The optimization analysis of step 116 involves performing all of the user selected “turned on” failure analyses to all user selected “turned on” load cases, for all structural components of the assembly defined by the model data. Failure analyses can include, for example, panel buckling, flexural torsional buckling, post buckling, crippling, ply and laminate based material strength based on appropriate composite tape and fabric stress/strain allowables that are adjusted with associated correction factors that account for laminate ply angle percentages, temperatures, and damage tolerance. Such optimization analysis routines are well known in the art and are in use in conventional design products (e.g., HYPERSIZER available from Collier Research and Development Corporation, Hampton, Va.).

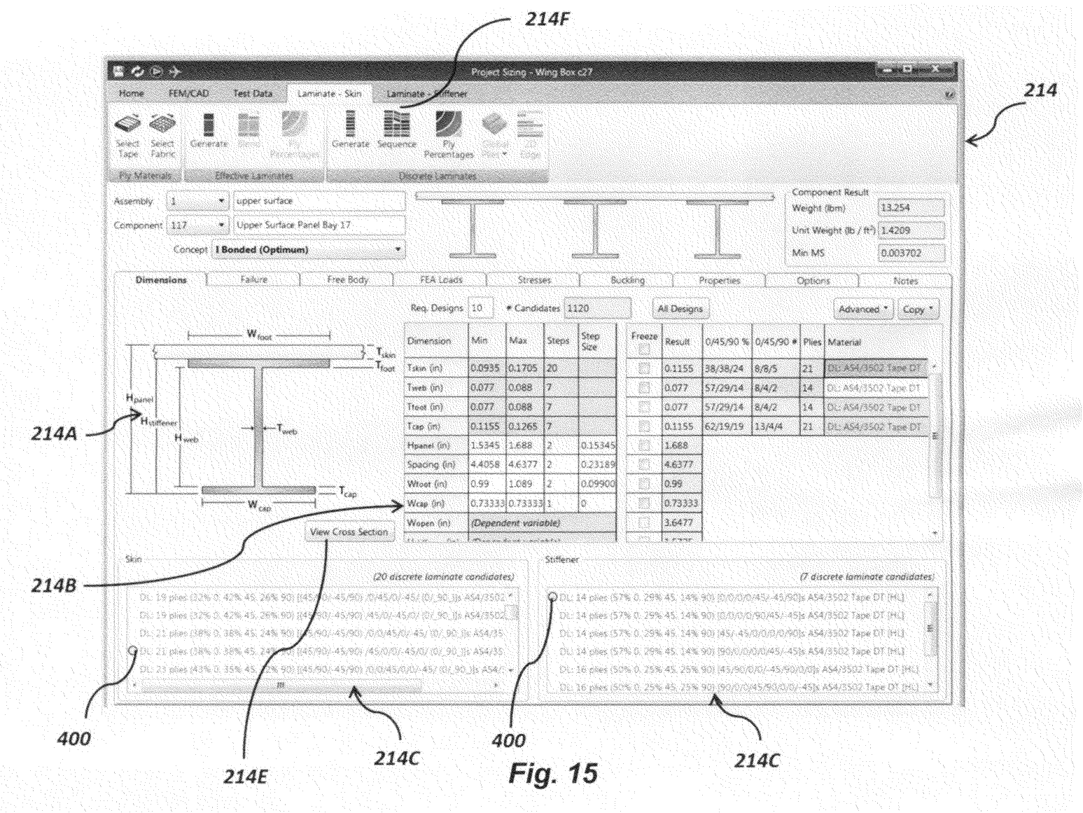

At the conclusion of the optimization step 116, display 20 is provided with information concerning the optimum candidate. More specifically and as shown in FIG. 15, step 118 updates user interface 214 so that the optimum fabrication design ply-by-ply definition is indicated with a visual indication using, for example, “circle markers” 400. Since the optimum candidate is indicated right on a user interface used in the design, a user can readily “back up” through the design process to review or to make changes. The optimum candidate cross-sectional shape and ply layup can be presented visually via the “View Cross Section” button 214E illustrated in FIG. 15 resulting in the generated images in FIGS. 16A and 16B where color of a ply indicates its ply angle (i.e., 0, +45, −45, or 90). In FIGS. 16A and 16B, the different colors are illustrated as different gray scales. However, it is to be understood that in an actual implementation of the present invention, the choice of colors used for the different ply angles would provide for ready visual distinction.

An “I” shaped and a “T” shaped panel concept are displayed in FIGS. 16A and 16B, respectively, to highlight the differences in optimal fabrication designs of the ply layups throughout the cross sections. The user/designer can enlarge portions of these displays to more easily view the ply angles. For example, FIG. 16C is a screenshot of an enlarged view of a rib-to-skin interface to more clearly show ply angles. Both designs can support the same amount of load, so the selection of which design to use is now based primarily on a company's fabrication technology. In particular, the manner in which to fabricate the stiffener is essential to the cost effective feasibility of the part. In this regard, conventional design optimization routines do not produce this insight and so the invention herein provides a unique capability for the user to specify their actual fabrication steps such as applying sublaminate ply packs and ply charges via view 208D of the user interface shown in FIG. 9. The user selected preferences along with the optimization carried out by processor 16 provides the data needed to produce the visual confirmation in FIGS. 16A-16C, and explicit fabrication layup schedules for import into CAD drawing computer models.

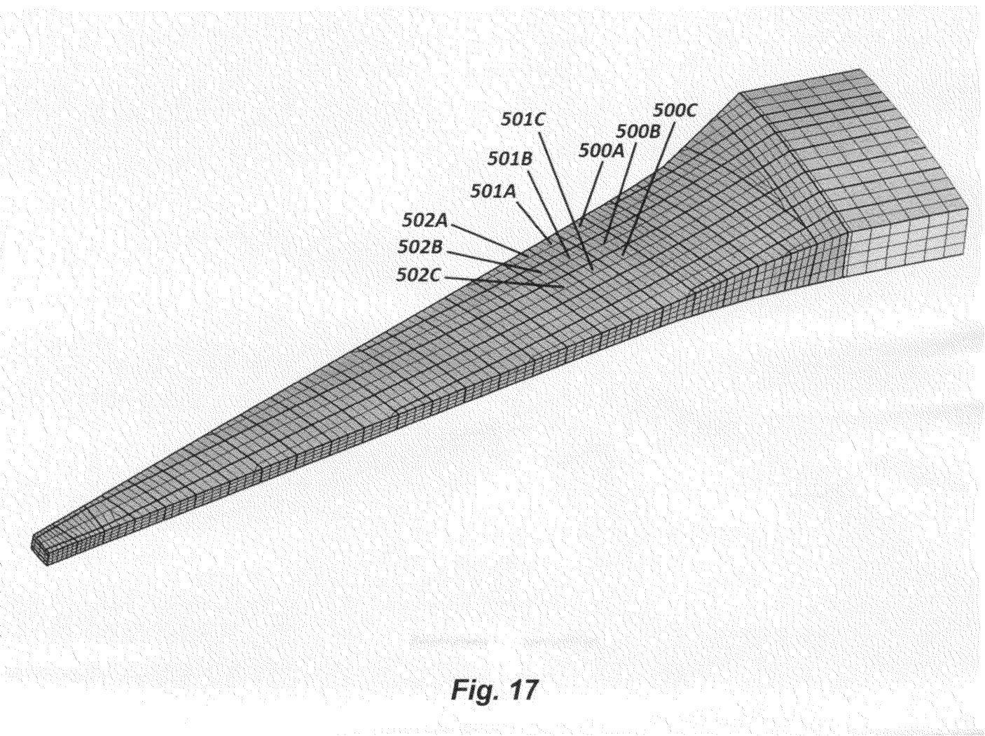

As mentioned above, the optimum fabrication design candidate provided by the present invention yields a ply-by-ply definition for a composite structure fabrication design. In general, a fabrication design of the present invention is defined for all components of a structural assembly. For example, as shown in FIG. 17, a wing box 500 is defined by multiple components (such as those referenced by numerals 500A-500C, 501A-501C, and 502A-502C as indicated by the bold line separators) that are arranged contiguously. The ultimate/optimum fabrication design provided by the present invention provides ply-by-ply definitions for each component. While the present invention yields an optimum solution on a component-by-component basis, a layup fabrication of the plies for the optimum fabrication design candidate can result in discontinuities between components. Accordingly, it may be necessary to further re-sequence the ply-by-ply definition of the optimum candidate to minimize discontinuities between the components. Such re-sequencing can be requested by accessing the “Sequencing” button on toolbar 214F (FIG. 15) whereby a portion of the computer program is executed at step 120 (indicated as an optional additional step by use of dashed lines) to minimize component-to-component discontinuities during a layup operation. A variety of re-sequencing operations known in the art could be applied for one-dimensional sequencing without departing from the scope of the present invention.

The advantages of the present invention are numerous. Composite structure fabrication design is streamlined as fabrication rule selection interfaces are presented to a user/designer in a logical and comprehensive fashion. User selections of fabrication rules are integrated into the candidate selection process. The variety of rule options allows the present invention to be utilized by a wide variety of end users having different internal, customer, and regulatory fabrication criteria that must be considered when designing a composite structure.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A computer system for generating a composite-structure fabrication design, comprising:
a database for storing data to include analysis templates, material data, and model data;
a memory device for storing a computer program;
a display device for generating visual images of a plurality of user interfaces;
an input device for receiving user selections; and
a processor for executing said computer program, said processor being coupled to said database, said memory device, said input device, and said display device,
said computer program causing said display device to display a first subset of said user interfaces presenting selection options for said data,
said computer program applying said data identified by said selection options corresponding to said user selections to determine a composite structure model,
said computer program causing said display device to display a second subset of said user interfaces that illustrates structural components of the composite structure model, wherein said second subset of said user interfaces provides access to ones of said user interfaces specifying fabrication rule options, and wherein fabrication rules are selected from said fabrication rule options via said user selections,
said computer program applying said fabrication rules selected to the composite structure model to determine a plurality of candidates for a composite structure fabrication based on the composite structure model, wherein each of said candidates defines a unique ply-by-ply definition of the composite structure fabrication,
said computer program causing said display device to display a third subset of said user interfaces that illustrates each said ply-by-ply definition,
said computer program performing an optimization routine on said plurality of candidates to select one of said plurality of candidates, and
said computer program updating said third subset of said user interfaces to visually indicate said one of said plurality of candidates selected.

2. A computer system as in claim 1, wherein said fabrication rule options comprise dimensionless cross-section ratio options for the structural components, sublaminate options for the structural components, tooling options for the structural components, ply angle options for the structural components, repair options for the structural components, and layup options for the structural components.

3. A computer system as in claim 1, wherein said computer program optimizes said ply-by-ply definition for said one of said plurality of candidates to minimize discontinuities in the composite structure fabrication.

4. A computer system as in claim 1, wherein the composite structure model comprises a plurality of model components arranged contiguously.

5. A computer system as in claim 4, wherein the composite structure fabrication comprises a plurality of fabrication components corresponding to said plurality of model components.

6. A computer system as in claim 5, wherein said computer program optimizes said ply-by-ply definition for said one of said plurality of candidates to minimize discontinuities between said plurality of fabrication components of the composite structure fabrication corresponding to said one of said plurality of candidates.

7. A computer system as in claim 1 wherein, after updating, said third subset of said user interfaces provides access on said display device to a ply-by-ply image of said one of said plurality of candidates selected, and wherein said ply-by-ply image visually indicates an angular orientation of each ply in said ply-by-ply image.

8. A method for executing a computer program on a processor to generate a composite-structure fabrication design, comprising the steps of:
providing a database that stores data to include analysis templates, materials data, and model data;
providing a display device that generates visual images of a plurality of user interfaces;
providing an input device that receives user selections;
executing said computer program to display on the display device a first subset of said user interfaces that presents selection options for said data;
receiving said user selections that identify ones of said selections options wherein said data associated therewith is identified;
executing said computer program to apply said data identified by said selection options corresponding to said user selections to determine a composite structure model;
executing said computer program to display on the display device a second subset of said user interfaces that illustrates structural components of the composite structure model, wherein said second subset of said user interfaces provides access to ones of said user interfaces specifying fabrication rule options;
receiving said user selections that identify fabrication rules from said fabrication rule options;
executing said computer program to apply said fabrication rules to the composite structure model to determine a plurality of candidates for a composite structure fabrication based on the composite structure model, wherein each of said candidates defines a unique ply-by-ply definition of the composite structure fabrication;
executing said computer program to display on the display device a third subset of said user interfaces that illustrates each said ply-by-ply definition;
executing said computer program to perform an optimization routine on said plurality of candidates to select one of said plurality of candidates; and
executing said computer program to update said third subset of said user interfaces on the display device to visually indicate said one of said plurality of candidates selected.

9. A method according to claim 8, wherein said fabrication rule options comprise dimensionless cross-section ratio options for the structural components, sublaminate options for the structural components, tooling options for the structural components, ply angle options for the structural components, repair options for the structural components, and layup options for the structural components.

10. A method according to claim 8, further comprising the step of executing said computer program to optimize said ply-by-ply definition for said one of said plurality of candidates to minimize discontinuities in the composite structure fabrication.

11. A method according to claim 8, wherein the composite structure model comprises a plurality of model components arranged contiguously.

12. A method according to claim 11, wherein the composite structure fabrication comprises a plurality of fabrication components corresponding to said plurality of model components.

13. A method according to claim 12, further comprising the step of executing said computer program to optimize said ply-by-ply definition for said one of said plurality of candidates to minimize discontinuities between said plurality of fabrication components of the composite structure fabrication corresponding to said one of said plurality of candidates.

14. A method according to claim 8, wherein said third subset of said user interfaces updated to visually indicate said one of said plurality of candidates selected provides access on the display device to a ply-by-ply image of said one of said plurality of candidates selected wherein, when accessed, said ply-by-ply image visually indicates an angular orientation of each ply in said ply-by-ply image.

15. A computer-readable medium comprising a computer program code which configures a computer system for the generation of a composite-structure fabrication design, wherein the computer system (i) stores data to include analysis templates, materials data, and model data, (ii) generates visual images of a plurality of user interfaces, and (iii) receives user selections in order to perform a method comprising:
displaying a first subset of said user interfaces presenting selection options for said data;
determining a composite structure model using said data identified by said selection options corresponding to said user selections;
displaying a second subset of said user interfaces that illustrates structural components of the composite structure model, wherein said second subset of said user interfaces provides access to ones of said user interfaces specifying fabrication rule options, and wherein fabrication rules are selected from said fabrication rule options via said user selections;
determining, using said fabrication rules selected and the composite structure model, a plurality of candidates for a composite structure fabrication based on the composite structure model, wherein each of said candidates defines a unique ply-by-ply definition of the composite structure fabrication;
displaying a third subset of said user interfaces that illustrates each said ply-by-ply definition;
performing an optimization routine on said plurality of candidates to select one of said plurality of candidates; and
updating said third subset of said user interfaces to visually indicate said one of said plurality of candidates selected.

16. A computer-readable medium as in claim 15, wherein said fabrication rule options comprise dimensionless cross-section ratio options for the structural components, sublaminate options for the structural components, tooling options for the structural components, ply angle options for the structural components, repair options for the structural components, and layup options for the structural components.

17. A computer-readable medium as in claim 15, further performing an optimization on said ply-by-ply definition for said one of said plurality of candidates to minimize discontinuities in the composite structure fabrication.

18. A computer-readable medium as in claim 15, wherein the composite structure model comprises a plurality of model components arranged contiguously.

19. A computer-readable medium as in claim 18, wherein the composite structure fabrication comprises a plurality of fabrication components corresponding to said plurality of model components.

20. A computer-readable medium as in claim 19, further performing an optimization on said ply-by-ply definition for said one of said plurality of candidates to minimize discontinuities between said plurality of fabrication components of the composite structure fabrication corresponding to said one of said plurality of candidates.

21. A computer-readable medium as in claim 15 wherein, after updating, said third subset of said user interfaces provides access to a ply-by-ply image of said one of said plurality of candidates selected, wherein said ply-by-ply image visually indicates an angular orientation of each ply therein.
